(19) United States
(12) Patent Application Publication
(10) Pub. No.: US 2010/0119816 A1
(43) Pub. Date: May 13, 2010

(54) HEAT-PEELABE PRESSURE-SENSITIVE ADHESIVE SHEET CONTAINING LAYERED SILICATE AND PROCESS FOR THE PRODUCTION FOR ELECTRONIC COMPONENTS BY THE USE OF THE SHEET

(75) Inventors: Daisuke Shimokawa, Osaka (JP); Hiroyuki Kondo, Osaka (JP); Yukio Arimitsu, Osaka (JP); Tomoko Kishimoto, Osaka (JP)

Correspondence Address: EDWARDS ANGELL PALMER & DODGE LLP, P.O. BOX 55874, BOSTON, MA, 02205, US

(73) Assignee: NITTO DENKO CORPORATION, Ibaraki-shi (JP)

(21) Appl. No.: 12/450,933

(22) PCT Filed: Apr. 15, 2008
(86) PCT No.: PCT/JP2008/057361

§ 371 Date: Oct. 19, 2009

(30) Foreign Application Priority Data
Apr. 20, 2007 (JP) 207-111390

(51) Int. Cl. C09J 7/02; C09J 11/04; C09J 11/08; C09J 201/00

(52) U.S. Cl. 428/324; 156/235; 156/250; 156/89.12; 428/355 RA

(57) ABSTRACT

Provided is a heat-peelable pressure-sensitive adhesive sheet which is resistant to deformation caused by pressurization, excels in cohesive strength, maintains an adequate adhesive strength until the temperature reaches a heating-peeling treatment temperature, and can be easily removed by heating. Also provided is a process for the production of electronic components using the above-mentioned sheet.

The heat-peelable pressure-sensitive adhesive sheet includes a substrate and, arranged on or above at least one side thereof, a heat-peelable pressure-sensitive adhesive layer containing heat-expandable microspheres and a layered silicate. The silicate is preferably present in a content of 1 to 200 parts by weight per 100 parts by weight of a base polymer constituting the heat-peelable pressure-sensitive adhesive layer.

### TECHNICAL FIELD

The present invention relates to a heat-peelable pressure-sensitive adhesive sheet that is easily peelable from an adherend through a heating treatment. It also relates to a process for the production of electronic components using the heat-peelable pressure-sensitive adhesive sheet, and to the resulting electronic components.

### BACKGROUND ART

Miniaturization and higher precision have been recently required of electronic components. Typically, ceramic capacitors, ceramic resistors, and ceramic inductors, as ones of ceramic electronic components, have been miniaturized to have smaller sizes represented by “0603” and “0402” sizes. They have also had larger capacities by piling up several hundreds or more of layers. Among such ceramic electronic components, ceramic capacitors require high processing accuracy in their production steps, so as to be miniaturized and to have higher precision (overall accuracy).

Exemplary production steps of ceramic capacitors include (1) a step of printing electrodes'on a green sheet, (2) a laminating step, (3) a high-pressure pressing step, (4) a cutting step, (5) a firing step, and (6) a step of applying and drying external electrodes. The laminating step (2) and the high-pressure pressing step (3) are often repeated two or more times according to the purpose. Each step requires accuracies. For example, the step (1) typically requires accuracy of electrode printing; the step (2) typically requires accuracy of position of electrodes; the step (3) requires accuracy of preventing misregistration of electrodes, which misregistration is caused by deformation of green sheets due to pressurization; and the step (4) typically requires accuracy of cutting. If even one of these accuracies required in the steps is low, rejects are included in products, and this lowers the productivity.

In these production steps, laying works are generally performed typically on a PET film or a tape. As such sheets or tapes, pressure-sensitive adhesive sheets are often employed in the production, for the purpose of miniaturization of products and affixation (adhesion) of green sheets during the cutting step (4). A variety of heat-peelable pressure-sensitive adhesive sheets have been proposed as pressure-sensitive adhesive sheets for this use (for example, Patent Document 1).

The steps (1) and (2) require mechanical accuracies, and such mechanical accuracies can be ensured through modifications and improvements in accuracy of apparatuses to be used. The pressing step (3), however, has suffered typically from poor accuracy of position of electrodes. This is because the pressing causes the pressure-sensitive adhesive layer of the tape to deform, the green sheets affixed on the tape follow the deformation of the tape and thereby deform, and this causes poor accuracy of electrode position. The poor accuracy (accuracy failure) caused by pressing upon lamination is not liable to occur when a material having a high elastic modulus at ordinary temperature, such as PET film, is used.

In the cutting step (4), the pressure-sensitive adhesive sheet should securely fix the green sheets during cutting and should be easily removed from the green sheets after cutting. Heat-peelable pressure-sensitive adhesive sheets have been used as pressure-sensitive adhesive sheets that satisfy these requirements. In recent years, cutting is performed in a high-temperature atmosphere so as to soften the green sheets for the improvement of cutting accuracy. In addition, such a pressure-sensitive adhesive sheet should be affixed to a smaller and smaller area of each chip, because of miniaturization of chips. Known heat-peelable pressure-sensitive adhesive sheets, however, show a significantly lower adhesive strength in a high-temperature atmosphere than that at room temperature and thereby do not sufficiently hold the chips during cutting in a high-temperature atmosphere, and this causes separation of the chips during cutting, resulting in a low yield.

In the step (6) of applying and drying external electrodes, a material for external electrodes is applied to both ends of chips typically of ceramic capacitors, for example, by a process of inserting chips into holes of a perforated silicone rubber sheet and applying the material to exposed ends of the chips. A rubber sheet having holes corresponding to the size and shape of chips is employed. The accuracy required to insert the chips into the holes increases with a decreasing size of chips, and this increases the difficulty of inserting operation. To avoid the problem, it is useful to employ heat-peelable pressure-sensitive adhesive sheets in the production process. An actual step of applying external electrodes using heat-peelable pressure-sensitive adhesive sheets is performed according typically to the following procedure. Specifically, chip-like electronic components are arrayed on a first heat-peelable pressure-sensitive adhesive sheet, and a material for external electrodes is applied to one end of each of the electronic components, the applied material is dried to give external electrodes on the electronic components, and a second heat-peelable pressure-sensitive adhesive sheet is affixed to the external electrodes on the electronic components. Next, the first heat-peelable pressure-sensitive adhesive sheet is heated to lower its adhesive strength, the chip-like electronic components are removed from the first heat-peelable pressure-sensitive adhesive sheet but are transferred to (remain on) the second pressure-sensitive adhesive sheet, and a material for external electrodes is applied to exposed sides of the chip-like electronic components to which the first pressure-sensitive adhesive sheet has been affixed. This process, however, suffers that heat applied to the first heat-peelable pressure-sensitive adhesive sheet travels also to the second heat-peelable pressure-sensitive adhesive sheet and thereby lowers also the adhesive strength of the second heat-peelable pressure-sensitive adhesive sheet, and the second heat-peelable pressure-sensitive adhesive sheet fails to hold the chips.

### Patent Document 1: Japanese Unexamined Patent Application Publication (JP-A) No. 2001-131507

### DISCLOSURE OF INVENTION

### Problems to be Solved by the Invention

An object of the present invention is to provide a heat-peelable pressure-sensitive adhesive sheet which has a pressure-sensitive adhesive layer resistant to deformation upon application of pressure during a high-pressure pressing step and which is advantageously usable typically as a pressure-sensitive adhesive, sheet for use in workings of electronic components.

Another object of the present invention is to provide a heat-peelable pressure-sensitive adhesive sheet in which a pressure-sensitive adhesive layer shows a sufficient holding power (shear adhesion) even in a high-temperature atmosphere. This heat-peelable pressure-sensitive adhesive sheet exhibits a sufficient holding power when used as a pressure-sensitive adhesive sheet in workings of chip-like electronic components and thereby advantageously prevents chip separation during a cutting step, especially through force-cutting (pressing and cutting), performed in a high-temperature atmosphere.

Yet another object of the present invention is to provide a heat-peelable pressure-sensitive adhesive sheet that shows a certain adhesive strength even in a high-temperature atmosphere but, once an aimed bonding operation is accomplished, can be immediately removed from adherends through heating.

Another object of the present invention is to provide a process for the production of electronic components using the heat-peelable pressure-sensitive adhesive sheet and to provide electronic components produced by the process.

### Means for Solving the Problems

After intensive investigations to achieve the objects, the present inventors have found that a desired pressure-sensitive adhesive sheet is obtained by incorporating a layered silicate into a pressure-sensitive adhesive which contains heat-expandable microspheres and constitutes a pressure-sensitive adhesive layer of the heat-peelable pressure-sensitive adhesive sheet. The resulting pressure-sensitive adhesive sheet exhibits a certain holding power and a certain adhesive strength even in a high-temperature atmosphere, because the pressure-sensitive adhesive has a higher cohesive strength, and the pressure-sensitive adhesive layer is thereby resistant to deformation even upon application of a pressure. The present invention has been made based on these findings.

Specifically the present invention provides, in an embodiment, a heat-peelable pressure-sensitive adhesive sheet which includes a substrate and, arranged on or above at least one side thereof, a heat-peelable pressure-sensitive adhesive layer containing heat-expandable microspheres and a layered silicate.

The layered silicate is preferably present in a content of from 1 to 200 parts by weight per 100 parts by weight of a base polymer constituting the heat-peelable pressure-sensitive adhesive layer.

In another embodiment, the present invention provides a process for producing an electronic component, which process includes the steps of stacking two or more green sheets bearing one or more printed electrodes thereon to give a laminate; and pressing the laminate to give a multilayer green sheet. The present invention further provides an electronic component produced by the process.

In still another embodiment, the present invention provides a process for producing the electronic component. The process includes the steps of affixing a multilayer ceramic sheet to the heat-peelable pressure-sensitive adhesive sheet; and cutting the multilayer ceramic sheet on the pressure-sensitive adhesive sheet to give a chip-like electronic component. The present invention further provides electronic components produced by the process.

In another embodiment, the present invention provides a process for producing a chip-like electronic component having an external electrode. The process includes the steps of arraying the chip-like electronic component on an adhesive face of a first heat-peelable pressure-sensitive adhesive sheet; providing an external electrode on a side of the chip-like electronic component opposite to the first heat-peelable pressure-sensitive adhesive sheet; affixing the heat-peelable pressure-sensitive adhesive sheet according to the present invention to the resulting external electrode on the chip-like electronic component; removing the first heat-peelable pressure-sensitive adhesive sheet from the chip-like electronic component through heating to expose a side of the chip-like electronic component; and providing another external electrode on the exposed side of the chip-like electronic component from which the first heat-peelable pressure-sensitive adhesive sheet has been removed.

### Advantages

The heat-peelable pressure-sensitive adhesive sheet according to the present invention is resistant to deformation of its heat-peelable pressure-sensitive adhesive layer even when subjected to repeated high-pressure pressing operations and shows a high cohesive strength and satisfactory adhesive properties even in a high-temperature atmosphere. The heat-peelable pressure-sensitive adhesive sheet is therefore advantageously usable as a pressure-sensitive adhesive sheet for use in workings of electronic components such as multilayer ceramic electronic components. Typically, the heat-peelable pressure-sensitive adhesive sheet, when used in the step of laminating and pressing green sheets, is resistant to displacement and deformation of its pressure-sensitive adhesive. It prevents chip separation during working and enables cutting with high accuracy when used in the step of cutting a multilayer green sheet performed in a high-temperature atmosphere typically through force-cutting. It also prevents chip separation during working and enables secured transfer of adherends from a first pressure-sensitive adhesive sheet to itself as a second pressure-sensitive adhesive sheet for the purpose of application of an electrode material when used in the step of applying external electrodes and transferring chips.

The heat-peelable pressure-sensitive adhesive sheet according to the present invention, when used as a pressure-sensitive adhesive sheet for workings in respective steps for the production of electronic components, improves the accuracy and efficiency of the working and thereby improves the yield. Additionally, the resulting chip-like electronic components have very high quality.

Once an aimed bonding operation is accomplished, the heat-peelable pressure-sensitive adhesive sheet can be easily removed from adherend electronic components through a heating-peeling treatment without applying stress thereto.

### BRIEF DESCRIPTION OF DRAWINGS

FIG. 1 is a schematic cross-sectional view showing a heat-peelable pressure-sensitive adhesive sheet according to an embodiment of the present invention.

FIG. 2 is a schematic cross-sectional view explaining the step of preparing a multilayer green sheet in a process for the production of electronic components according to an embodiment of the present invention.

FIG. 3 is a schematic cross-sectional view showing the step of providing external electrodes in a process for the production of chip-like electronic components having external electrodes, according to an embodiment of the present invention.

### REFERENCE NUMERALS

11 substrate

12 rubber-like organic elastic layer

13 heat-peelable pressure-sensitive adhesive layer

14 release layer

21 heat-peelable pressure-sensitive adhesive sheet according to the present invention

22 green sheet

23 internal electrode

31 first heat-peelable pressure-sensitive adhesive sheet

32 chip-like electronic component

33 external electrode

34 heat-peelable pressure-sensitive adhesive sheet according to the present invention

### BEST MODE FOR CARRYING OUT THE INVENTION

### [Heat-Peelable Pressure-Sensitive Adhesive Sheet]

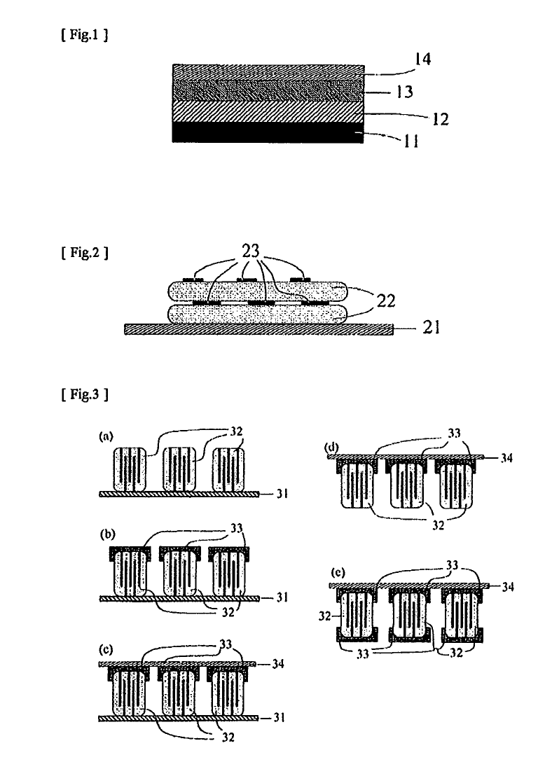

The configuration of heat-peelable pressure-sensitive adhesive sheets according to the present invention will be described below with reference to the attached drawings according to necessity. FIG. 1 is a schematic cross-sectional view showing part of a heat-peelable pressure-sensitive adhesive sheet according to an embodiment of the present invention. In FIG. 1, the reference numerals “11” stands for a substrate, “12” stands for a rubber-like organic elastic layer, “13” stands for a heat-peelable pressure-sensitive adhesive layer, and “14” stands for a release layer. The rubber-like organic elastic layer 12 and release layer 14 are layers provided according to necessity and are not essential in the heat-peelable pressure-sensitive adhesive sheets according to the present invention. A heat-peelable pressure-sensitive adhesive sheet according to another embodiment of the present invention can be a double-sided pressure-sensitive adhesive sheet which includes a substrate 11 and, arranged on both sides thereof, pressure-sensitive adhesive layers. It is enough that the heat-peelable pressure-sensitive adhesive sheet according to this embodiment has a heat-peelable pressure-sensitive adhesive layer as one of the two pressure-sensitive adhesive layers. The other pressure-sensitive adhesive layer may contain either of a heat-peelable pressure-sensitive adhesive or a non-heat-peelable pressure-sensitive adhesive (containing no heat-expandable microspheres).

### [Heat-Peelable Pressure-Sensitive Adhesive Layer]

The heat-peelable pressure-sensitive adhesive layer 13 includes a heat-peelable pressure-sensitive adhesive containing heat-expandable microspheres and a layered silicate. The presence of a blowing agent, such as heat-expandable microspheres, in the pressure-sensitive adhesive layer reduces the adhesion area between the pressure-sensitive adhesive layer and an adherend during a heating treatment, because the heat-expandable microspheres expand or swell by heating. Thus, the pressure-sensitive adhesive sheet is removed from the adherend.

### [Heat-Expandable Microspheres]

Exemplary heat-expandable microspheres for use herein include heat-expandable microspheres that contain a shell-forming material and, present inside thereof, a suitable material that can easily gasify and expand, such as isobutane, propane, or pentane. These heat-expandable microspheres may be prepared typically by a coacervation method or interfacial polymerization method. Exemplary shell-forming materials usable herein include materials that melt upon heating or that break as a result of thermal expansion, such as vinylidene chloride-acrylonitrile copolymers, poly(vinyl alcohol)s, poly(vinyl butyral)s, poly(methyl methacrylate)s, polyacrylonitriles, poly(vinylidene chloride)s, and polysulfones. Preferred heat-expandable microspheres for use herein are those having a ratio of cubic expansion of, for example, 5 times or more, preferably 7 times or more, and especially preferably 10 times or more, for satisfactory heat peelability.

The amount of the heat-expandable microspheres is not especially limited and can be suitably chosen depending on how much degree the heat-peelable pressure-sensitive adhesive layer 13 should expand (blister) and how much degree the adhesive strength should be decreased. The amount can be chosen within ranges of, for example, from 1 to 150 parts by weight, and preferably from 25 to 100 parts by weight, per 100 parts by weight of a base polymer constituting the heat-peelable pressure-sensitive adhesive layer mentioned below.

### [Layered Silicate]

The layered silicate is a clay mineral having a crystal structure formed mainly by a stack of clay layers each having a two-dimensional structure. The layered silicate, when placed in a solvent, swells to broaden distances between respective layers. In addition, it can take ions and molecules in between the layers while maintaining the layered structure. Such layered silicates for use herein are not especially limited, as long as capable of dispersing in the base polymer constituting the after-mentioned heat-peelable pressure-sensitive adhesive layer 13. Specific examples thereof include smectite, saponite, sauconite, stevensite, hectorite, margarite, talc, phlogopite, chrysotile, chlorite, vermiculite, kaolinite, muscovite, xanthophyllite, dickite, nacrite, pyrophillite, montmorillonite, beidellite, nontronite, tetrasilicic mica, sodium teniolite, antigorite, and halloysite. The layered silicate can be any of naturally-occurring layered silicates and synthetic layered silicates. The average length of particles constituting the layered silicate advantageously usable herein is preferably from 0.01 to 100 μm, and especially preferably from 0.05 to 10 μm. The aspect ratio thereof is preferably from 20 to 500, and especially preferably from 50 to 200. Each of different layered silicates can be chosen and used alone or in combination.

The content of the layered silicate(s) can be chosen within ranges of from 1 to 300 parts by weight per 100 parts by weight of a base polymer constituting the after-mentioned heat-peelable pressure-sensitive adhesive layer 13. The presence of the layered silicate(s) provides various advantages. For example, the pressure-sensitive adhesive layer has an increased cohesive strength so as to be resistant to deformation caused by pressure; the pressure-sensitive adhesive layer shows improved thermal stability, has an increased adhesive strength especially in a high-temperature atmosphere, and thereby adheres firmly to the adherend until the temperature reaches an intended peeling temperature. However, layered silicates, if present in an excessively large amount, may adversely affect the adhesive strength. The content of the layered silicates may therefore be chosen suitably so that the properties such as adhesive strength, thermal stability, and resistance to pressure be within desired ranges. Layered silicates, if present in a content of 1 part by weight or less, may not sufficiently provide the advantages; and, if present in a content of 300 parts by weight or more, may be difficult to disperse satisfactorily in the base polymer, being impractical. The content of layered silicates can be chosen within ranges of desirably 1 to 200 parts by weight, preferably 5 to 200 parts by weight, more preferably 5 to 100 parts by weight, and especially preferably 10 to 60 parts by weight, per 100 parts by weight of the base polymer, for maintaining satisfactory adhesive properties.

### [Base Polymer]

A heat-peelable pressure-sensitive adhesive constituting the heat-peelable pressure-sensitive adhesive layer 13 contains the heat-expandable microspheres, the layered silicate, and a base polymer. The base polymer is not especially limited, as long as allowing expansion and/or swelling of the heat-expandable microspheres upon heating and can be suitably chosen from among known or common base polymers for constituting pressure-sensitive adhesives. Base polymers preferably used herein are those which restrict the expansion and/or swelling of the heat-expandable microspheres to minimum extent. Exemplary base polymers include polymers such as natural rubbers, synthetic rubbers, acrylic polymers, vinyl alkyl ether polymers, silicone polymers, polyesters, polyamides, urethane polymers, and styrene-diene block copolymers. These polymers may be incorporated with one or more hot-melt (thermofusible) resins having a melting point of about 200° C. or lower so as to improve their creep properties.

Among these base polymers, acrylic copolymers are preferably used. Such acrylic copolymers preferably contain, as a main monomer component, an alkyl (meth)acrylate having an alkyl group with 20 or less carbon atoms. Exemplary alkyl groups with 20 or less carbon atoms include methyl group, ethyl group, propyl group, butyl group, amyl group, hexyl group, heptyl group, 2-ethylhexyl group, isooctyl group, isodecyl group, dodecyl group, lauryl group, tridecyl group, pentadecyl group, hexadecyl group, heptadecyl group, octadecyl group, nonadecyl group, and eicosyl group. Each of different alkyl(meth)acrylates can be used alone or in combination as main monomer components. Such alkyl(meth)acrylates generally occupy 50 percent by weight or more of the base polymer constituting the pressure-sensitive adhesive.

Where necessary, the acrylic copolymer may further contain suitable copolymerizable monomers, in addition to the alkyl(meth)acrylates, in order typically to improve or modify the properties such as cohesive strength and thermal stability. Exemplary copolymerizable monomers include carboxyl-containing monomers such as acrylic acid, methacrylic acid, carboxyethyl acrylate, carboxypentyl acrylate, itaconic acid, maleic acid, fumaric acid, and crotonic acid; acid anhydrides such as maleic anhydride and itaconic anhydride; hydroxyl-containing monomers such as hydroxyethyl(meth)acrylates, hydroxypropyl(meth)acrylates, hydroxybutyl(meth)acrylates, hydroxyhexyl(meth)acrylates, hydroxyoctyl(meth)acrylates, hydroxydecyl(meth)acrylates, hydroxylauryl(meth)acrylates, and (4-hydroxymethylcyclohexyl)methyl(meth)acrylates; sulfo-containing monomers such as styrenesulfonic acid, allylsulfonic acid, 2-(meth)acrylamido-2-methylpropanesulfonic acid, (meth)acrylamidopropanesulfonic acids, sulfopropyl(meth)acrylates, and (meth)acryloyloxynaphthalenesulfonic acid; (meth)acrylamides and (N-substituted)amide monomers such as N,N-dimethyl(meth)acrylamides, N-butyl(meth)acrylamides, N-methylol(meth)acrylamides, and N-methylolpropane(meth)acrylamides; alkylamino(meth)acrylate monomers such as aminoethyl(meth)acrylates, N,N-dimethylaminoethyl(meth)acrylates, and t-butylaminoethyl(meth)acrylates; alkoxyalkyl(meth)acrylate monomers such as methoxyethyl(meth)acrylates and ethoxyethyl(meth)acrylates; maleimide monomers such as N-cyclohexylmaleimide, N-isopropylmaleimide, N-laurylmaleimide, and N-phenylmaleimide; itaconimide monomers such as N-methylitaconimide, N-ethylitaconimide, N-butylitaconimide, N-octylitaconimide, N-2-ethylhexylitaconimide, N-cyclohexylitaconimide, and N-laurylitaconimide; succinimide monomers such as N-(meth)acryloyloxymethylenesuccinimide, N-(meth)acryloyl-6-oxyhexamethylenesuccinimide, and N-(meth)acryloyl-8-oxyoctamethylenesuccinimide; vinyl monomers such as vinyl acetate, vinyl propionate, N-vinylpyrrolidone, methylvinylpyrrolidone, vinylpyridine, vinylpiperidone, vinylpyrimidine, vinylpiperazine, vinylpyrazine, vinylpyrrole, vinylimidazole, vinyloxazole, vinylmorpholine, N-vinylcarboxamides, styrene, α-methylstyrene, and N-vinylcaprolactam; cyanoacrylate monomers such as acrylonitrile and methacrylonitrile; epoxy-containing acrylic monomers such as glycidyl(meth)acrylates; glycolic acrylate monomers such as polyethylene glycol(meth)acrylates, polypropylene glycol(meth)acrylates, methoxyethylene glycol(meth)acrylates, and methoxypolypropylene glycol(meth)acrylates; other acrylic ester monomers such as tetrahydrofurfuryl(meth)acrylates, fluorinated(meth)acrylates, silicone(meth)acrylates, and 2-methoxyethyl acrylate; multifunctional monomers such as hexanediol di(meth)acrylates, (poly)ethylene glycol di(meth)acrylates, (poly)propylene glycol di(meth)acrylates, neopentyl glycol di(meth)acrylates, pentaerythritol di(meth)acrylates, trimethylolpropane tri(meth)acrylates, pentaerythritol tri(meth)acrylates, dipentaerythritol hexa(meth)acrylates, epoxy acrylates, polyester acrylates, and urethane acrylates; and other monomers such as isoprene, butadiene, isobutylene, and vinyl ethers. Each of different copolymerizable monomers can be used alone or in combination.

The base polymer constituting the heat-peelable pressure-sensitive adhesive layer 13 can be prepared by subjecting the monomer(s) to polymerization. Though not especially limited, the polymerization can be performed by adding a polymerization initiator and carrying out a polymerization process suitably chosen from known regular polymerization processes such as solution polymerization, bulk polymerization, and emulsion polymerization.

Where necessary, the pressure-sensitive adhesive constituting the heat-peelable pressure-sensitive adhesive layer 13 may further contain a variety of additives. Exemplary additives include known or common tackifier resins such as rosin resins, terpene resins, petroleum resins, coumarone-indene resins, and styrenic resins; crosslinking agents such as epoxy crosslinking agents, isocyanate crosslinking agents, and multifunctional acrylate crosslinking agents; fillers; colorants such as pigments and dyestuffs; antioxidants; ultraviolet-absorbers; surfactants; and other known additives. These additives may be used each in an amount generally employed in pressure-sensitive adhesives.

The thickness of the heat-peelable pressure-sensitive adhesive layer 13 can be chosen within a range of, for example, from 5 to 300 μm. The heat-peelable pressure-sensitive adhesive layer, if having a thickness less than the largest particle diameter of the heat-expandable microspheres contained therein, may lose surface smoothness and thereby show an insufficient adhesive strength before heating, because the heat-expandable microspheres appear as protrusions on the surface of the layer. The heat-peelable pressure-sensitive adhesive layer, if having a large thickness more than necessary, may suffer from cohesive failure due to expansion of the heat-expandable microspheres upon peeling by heating, and this may cause inferior heat-peelability. For example, adhesive transfer to the adherend may occur. The thickness of the heat-peelable pressure-sensitive adhesive layer may be suitably chosen so that the adhesive strength and peelability fall within desired ranges. Typically, the thickness can be chosen within ranges of preferably from 5 to 50 μm, and especially preferably from 15 to 35 μm when the heat-peelable pressure-sensitive adhesive sheet is used as a pressure-sensitive adhesive sheet in the step of cutting a green sheet. Separately, the thickness can be chosen within ranges of preferably from 20 to 150 μm, and especially preferably from 20 to 100 μm, when the heat-peelable pressure-sensitive adhesive sheet is used as a pressure-sensitive adhesive sheet in the step of laminating and high-pressure pressing or used as a pressure-sensitive adhesive sheet in the step of applying external electrodes.

### [Substrate]

The substrate 11 can be any of suitable thin materials without limitation. Examples of such thin materials include paper, cloths, nonwoven fabrics, metallic foil, and laminates of them with a plastic, as well as laminates of plastics. Though not critical, the thickness of the substrate 11 is usually from about 5 to about 250 μm.

### [Rubber-Like Organic Elastic Layer]

The heat-peelable pressure-sensitive adhesive sheet according to the present invention can include a rubber-like organic elastic layer 12. The rubber-like organic elastic layer 12 works as follows. Specifically, this layer helps the surface of the pressure-sensitive adhesive sheet to satisfactorily follow the surface dimensions of the adherend to thereby give a large adhesion area upon the affixation of the sheet to the adherend. Additionally, when the heat-peelable pressure-sensitive adhesive layer 13 is heated to expand and/or swell to thereby remove the pressure-sensitive adhesive sheet from the adherend, the rubber-like organic elastic layer 12 helps to reduce the restriction on the expansion and/or swelling in a plane direction of the pressure-sensitive adhesive sheet and thereby helps the heat-peelable pressure-sensitive adhesive layer 13 to change three-dimensionally in its structure and to form a wavy structure. The rubber-like organic elastic layer 12 is a layer provided according to necessity and may not necessarily be provided.

The rubber-like organic elastic layer 12 is preferably made from, for example, any of natural rubbers, synthetic rubbers, and synthetic resins having rubber elasticity, each of which has a Type D Shore D hardness of preferably 50 or less, and especially preferably 40 or less, as determined according to the American Society for Testing and Materials (ASTM) D-2240 standard. Examples of the synthetic rubbers and synthetic resins having rubber elasticity include nitrile rubbers, diene rubbers, acrylic rubbers, and other synthetic rubbers; polyolefins, polyesters, and other thermoplastic elastomers; ethylene-vinyl acetate copolymers, polyurethanes, polybutadienes, flexible poly(vinyl chloride)s, and other synthetic resins having rubber elasticity. Even inherently hard or rigid polymers, such as poly(vinyl chloride)s, can be used herein by suitably combining with compounding agents such as plasticizers and flexibilizers so as to exhibit rubber elasticity. The rubber-like organic elastic layer may be made from a polymer analogous to the base polymer of the pressure-sensitive adhesive constituting the heat-peelable pressure-sensitive adhesive layer 13.

The thickness of the rubber-like organic elastic layer 12 is, for example, from about 5 to about 300 μm, preferably from about 20 to about 150 μm, and more preferably from about 20 to about 100 μm. The rubber-like organic elastic layer 12, if having an excessively small thickness, may not sufficiently help the heat-peelable pressure-sensitive adhesive layer 13 to change three-dimensionally in its structure and to exhibit satisfactory peelability. The rubber-like organic elastic layer 12 may include a single layer or two or more layers.

### [Release Layer]

The release layer 14 is a layer provided for the protection of the surface of the heat-peelable pressure-sensitive adhesive layer 13 and will be removed when the heat-peelable pressure-sensitive adhesive layer 13 is applied to an adherend. The release layer 14 may be made typically of a suitable release paper. Specific examples of usable materials include base materials each having a release layer typically of a plastic film or paper whose surface has been treated with a releasing agent such as a silicone, long-chain alkyl, fluorine, or molybdenum sulfide releasing agent; low-adhesive base materials made from fluorocarbon polymers such as polytetrafluoroethylenes, polychlorotrifluoroethylenes, poly(vinyl fluoride)s, poly(vinylidene fluoride)s, tetrafluoroethylene-hexafluoropropylene copolymers, and chlorofluoroethylene-(vinylidene fluoride) copolymers; and low-adhesive base materials made from nonpolar polymers such as olefinic resins (e.g., polyethylenes and polypropylenes). The release layer 14 is provided according to necessity and may not be necessarily provided.

Though not especially limited, exemplary processes for providing the heat-peelable pressure-sensitive adhesive layer 13 on the substrate 11 include a process in which components such as the heat-expandable microspheres, layered silicate, and base polymer are uniformly mixed and dissolved in a solvent (for example, toluene) to give a coating composition, the coating composition is applied to the substrate to give a layer, and the applied layer is dried. Another exemplary process is a process in which the coating composition is applied typically to a release paper constituting the release layer 14 to form a heat-peelable pressure-sensitive adhesive layer 13 thereon, and the substrate 11 is then applied to the surface of the pressure-sensitive adhesive layer.

### [Heating-Peeling Treatment]

When the heat-peelable pressure-sensitive adhesive sheet according to the present invention is applied to an adherend, the sheet can be easily removed (peeled off) from the adherend by a heating treatment once an aimed bonding operation is accomplished. The heating treatment can be performed using a suitable heating device such as hot plate, hot-air drier (air-forced oven), or near-infrared lamp. The heating temperature has only to be equal to or higher than the expansion initiating temperature of the heat-expandable microspheres in the heat-peelable pressure-sensitive adhesive layer. Heating conditions may be suitably set according typically to how the adhesion area decreases depending typically on the surface condition of the adherend and the type of the heat-expandable microspheres; the thermal stability of the substrate and adherend; and the way to carry out the heating (e.g., heat capacity and heating device or process). In general, the heating is carried out at a temperature of from 100° C. to 250° C., for a duration of 1 to 90 seconds typically using a hot plate, or for a duration of 5 to 15 minutes typically using a hot air dryer (air forced oven). The heating treatment can be performed at a suitable stage according to the purpose of use. An infrared lamp or heated water (hot water) can be used as a heat source in some cases.

### [Process for Production of Electronic Components]

Though not especially limited, the pressure-sensitive adhesive sheets according to the present invention can be used as pressure-sensitive adhesive sheets for the temporary fixing, storage, and transportation of a variety of adherends. They are especially suitably used typically as temporary fixing members in working or processing of electronic components. They can be advantageously used in the production of chip-like electronic components such as multilayer ceramic capacitors and multilayer ceramic variable resistors. A process for the production of electronic components using the heat-peelable pressure-sensitive adhesive sheet according to the present invention will be described below. Chip-form electronic components according to the present invention are produced through one or more steps selected from (i) electrode printing step, (ii) laminating/pressing step, (iii) cutting step, (iv) firing step, and (v) external electrode applying step. The heat-peelable pressure-sensitive adhesive sheets according to the present invention are mainly suitably used in the laminating/pressing step (ii), cutting step (iii), and external electrode applying step (v). Use of them in these steps gives remarkable advantages such as improvements of operating accuracy and operating efficiency.

In the electrode printing step (i), internal electrodes having a predetermined pattern are printed on one side of a green sheet (ceramic green sheet) typically with an electroconductive paste to give a green sheet bearing printed electrodes.

In the (ii)laminating/pressing step, a required number of plies of the green sheet bearing printed electrodes, prepared from the step (i), are laminated or stacked so that a side bearing printed electrodes of one green sheet faces a side bearing no printed electrode of another green sheet, and the resulting laminate is pressed under high pressure to give a multilayer ceramic sheet. The high-pressure pressing is generally performed on a laminate of several plies of the green sheets bearing printed electrodes, and two or more (e.g., about 2 to about 50) pressing procedures are performed until a necessary number of plies of the green sheet is laminated to give a target multilayer ceramic sheet. FIG. 2 is a schematic cross-sectional view showing a preparation procedure of a multilayer green sheet in the laminating/pressing step (ii). In FIG. 2, the reference numerals “21” stands for a heat-peelable pressure-sensitive adhesive sheet according to the present invention, “22” stands for a ceramic sheet, and “23” stands for an internal electrode, respectively. With reference to FIG. 2, a multilayer green sheet is prepared by laminating or stacking green sheets bearing printed electrodes on the heat-peelable pressure-sensitive adhesive sheet 21 (on the adhesive face of the heat-peelable pressure-sensitive adhesive layer); pressing the resulting laminate; and repeating these laminating and pressing operation. The heat-peelable pressure-sensitive adhesive sheet 21 is resistant to deformation because of a layered silicate contained in the heat-peelable pressure-sensitive adhesive layer. The sheet is therefore resistant to displacement (adhesive squeeze-out) of the pressure-sensitive adhesive even during repeated high-pressure pressing operations and enables laminating and pressing with high accuracy. After the necessary number of green sheets are laminated and pressed, the multilayer ceramic sheet may be removed from the heat-peelable pressure-sensitive adhesive sheet through heating, or may be subjected to the subsequent step (cutting step (iii)) together with the heat-peelable pressure-sensitive adhesive sheet without removal through heating.

In the cutting step (iii), the multilayer ceramic sheet prepared from the laminating/pressing step (ii) is affixed to a heat-peelable pressure-sensitive adhesive sheet according to the present invention and cut (especially through force cutting) into chips of unit component size, to thereby give chip-like electronic components. The cutting is often performed in a high-temperature atmosphere so as to soften the green sheet to thereby improve cutting accuracy. Specifically, the cutting is often performed at a high temperature typically of 60° C. to 100° C., which is, however, lower than heating-peeling treatment temperature of the heat-peelable pressure-sensitive adhesive sheet. The heat-peelable pressure-sensitive adhesive sheet according to the present invention excels in thermal stability and cohesive strength, thereby develops sufficient adhesive strength and holding power even in such a high-temperature atmosphere, and prevents chip separation during working and resulting poor yield. Thus, the sheet helps to produce chip-like electronic components with high cutting accuracy. After the completion of cutting, the chip-like electronic components can be easily removed from the heat-peelable pressure-sensitive adhesive sheet through a heating-peeling treatment.

The multilayer green sheet cut into chips is subjected to the firing step (iv) and, where necessary, to the external electrode applying step (v). The step of providing (applying) external electrodes using a heat-peelable pressure-sensitive adhesive sheet according to the present invention will be illustrated with reference to FIG. 3. FIGS. 3(a), (b), (c), (d), and (e) are schematic cross-sectional views sequentially illustrating how external electrodes are provided on chip-like electronic components using the heat-peelable pressure-sensitive adhesive sheet according to the present invention. In FIGS. 3(a), (b), (c), (d), and (e), the reference numerals “31” stands for a first heat-peelable pressure-sensitive adhesive sheet; “32” stands for a chip-like electronic component; “33” stands for an external electrode; and “34” stands for the heat-peelable pressure-sensitive adhesive sheet according to the present invention, respectively. FIG. 3(a) shows how the chip-like electronic components 32 are arrayed on, and affixed to, an adhesive face of the first heat-peelable pressure-sensitive adhesive sheet 31. The first heat-peelable pressure-sensitive adhesive sheet 31 can be freely chosen from any of known or common heat-peelable pressure-sensitive adhesive sheets. Typically, the first heat-peelable pressure-sensitive adhesive sheet 31 may have the same configuration as the heat-peelable pressure-sensitive adhesive sheet according to the present invention, except for containing no layered silicate in the heat-peelable pressure-sensitive adhesive layer. Alternatively, a heat-peelable pressure-sensitive adhesive sheet according to the present invention may be used as the first heat-peelable pressure-sensitive adhesive sheet 31. FIG. 3(b) illustrates how the external electrodes 33 are provided on one side (side opposite to the pressure-sensitive adhesive sheet) of the chip-like electronic components 32. Next, the heat-peelable pressure-sensitive adhesive sheet 34 according to the present invention is applied as a second pressure-sensitive adhesive sheet to the sides of the chip-like electronic components 32 where the external electrodes 33 are provided (FIG. 3(c)), and the first heat-peelable pressure-sensitive adhesive sheet 31 is removed by heating. If a common heat-peelable pressure-sensitive adhesive sheet is used as the second pressure-sensitive adhesive sheet herein, heat applied to the first heat-peelable pressure-sensitive adhesive sheet 31 travels also to the second pressure-sensitive adhesive sheet to thereby reduce the adhesive strength of the second pressure-sensitive adhesive sheet, and the resulting second pressure-sensitive adhesive sheet may fail to firmly adhere to and hold the chip-like electronic components 32 bearing external electrodes 33 on one side thereof. In contrast, the heat-peelable pressure-sensitive adhesive sheet 34 according to the present invention, when used as a second heat-peelable pressure-sensitive adhesive sheet, can firmly adhere to and hold the adherends before, during, and after removal of the first heat-peelable pressure-sensitive adhesive sheet 31, because the sheet 34 excels in thermal stability and adhesive properties in a high-temperature atmosphere. Thus, the first heat-peelable pressure-sensitive adhesive sheet 31 can be removed while the external electrodes 33 on one side of the chip-like electronic components 32 are firmly bonded to and fixed by the heat-peelable pressure-sensitive adhesive sheet 34 according to the present invention, to thereby expose sides of the chip-like electronic components 32 where no external electrode 33 is provided (FIG. 3(d)). Next, another external electrode 33 is provided respectively on the exposed sides of the chip-like electronic components 32 from which the first heat-peelable pressure-sensitive adhesive sheet 31 has been removed, to give chip-like electronic components bearing external electrodes 33 on both ends thereof (FIG. 3(e))

### EXAMPLES

The present invention will be illustrated in further detail with reference to several examples below, which are, however, by no means construed to limit the scope of the present invention.

### Example 1

Rubber-Like Organic Elastic Layer

In toluene were dissolved 100 parts by weight of an acrylic copolymer and 2 parts by weight of an isocyanate crosslinking agent (supplied by Nippon Polyurethane Industry Co., Ltd. under the trade name “CORONATE L”) to give a composition; and the composition was applied to a polyester film 100 μm thick to give a rubber-like organic elastic layer having a thickness after drying of 15 μm. The acrylic copolymer used herein was composed of 70 parts by weight of 2-ethylhexyl acrylate, 30 parts by weight of ethyl acrylate, and 5 parts by weight of 2-hydroxyethyl acrylate.

Heat-Peelable Pressure-Sensitive Adhesive Layer

In toluene were uniformly dissolved 100 parts by weight of an acrylic copolymer, 1.5 parts by weight of an isocyanate crosslinking agent (supplied by Nippon Polyurethane Industry Co., Ltd. under the trade name “CORONATE L”), 10 parts by weight of a terpene phenol resin (supplied by Yasuhara Chemical Co., Ltd. under the trade name “YS Polyster T130”), 30 parts by weight of heat-expandable microspheres (supplied by Matsumoto Yushi-Seiyaku Co., Ltd. under the trade name “Microsphere F50D”), and 20 parts by weight of a layered silicate (supplied by CO-OP Chemical Co., Ltd. under the trade name “Synthetic Smectite MAE”) to give a coating composition; and the coating composition was applied to a separator to give a heat-peelable pressure-sensitive adhesive layer having a thickness after drying of 40 μm. The acrylic copolymer used herein was composed of 70 parts by weight of 2-ethylhexyl acrylate, 30 parts by weight of ethyl acrylate, and 5 parts by weight of 2-hydroxyethyl acrylate.

Heat-Peelable Pressure-Sensitive Adhesive Sheet

The rubber-like organic elastic layer was affixed to the heat-peelable pressure-sensitive adhesive layer and thereby yielded a heat-peelable pressure-sensitive adhesive sheet according to the present invention.

### Example 2

Rubber-Like Organic Elastic Layer

In toluene were dissolved 100 parts by weight of an acrylic copolymer and 3 parts by weight of an isocyanate crosslinking agent (supplied by Nippon Polyurethane Industry Co., Ltd. under the trade name “CORONATE L”) to give a composition; and the composition was applied to a polyester film 100 μm thick to give a rubber-like organic elastic layer having a thickness after drying of 15 μm. The acrylic copolymer used herein was composed of 100 parts by weight of butyl acrylate and 5 parts by weight of acrylic acid.

Heat-Peelable Pressure-Sensitive Adhesive Layer

In toluene were uniformly dissolved 100 parts by weight of an acrylic copolymer, 0.5 part by weight of an epoxy crosslinking agent (supplied by Mitsubishi Gas Chemical Company, Inc. under the trade name “TETRAD C”), 10 parts by weight of a terpene phenol resin (supplied by Yasuhara Chemical Co., Ltd. under the trade name “YS Polyster T130”), 50 parts by weight of heat-expandable microspheres (supplied by Matsumoto Yushi-Seiyaku Co., Ltd. under the trade name “Microsphere F50D”), and 50 parts by weight of a layered silicate (supplied by CO-OP Chemical Co., Ltd. under the trade name “Synthetic Smectite MAE”) to give a coating composition; and the coating composition was applied to a separator to give a heat-peelable pressure-sensitive adhesive layer having a thickness after drying of 40 μm. The acrylic copolymer used herein was composed of 100 parts by weight of butyl acrylate and 5 parts by weight of acrylic acid.

Heat-Peelable Pressure-Sensitive Adhesive Sheet

The rubber-like organic elastic layer was affixed to the heat-peelable pressure-sensitive adhesive layer and thereby yielded a heat-peelable pressure-sensitive adhesive sheet according to the present invention.

### Comparative Example 1

A heat-peelable pressure-sensitive adhesive sheet was prepared by the procedure of Example 1, except for not incorporating the layered silicate into the heat-peelable pressure-sensitive adhesive layer.

### Comparative Example 2

A heat-peelable pressure-sensitive adhesive sheet was prepared by the procedure of Example 2, except for not incorporating the layered silicate into the heat-peelable pressure-sensitive adhesive layer.

### (Evaluations)

The heat-peelable pressure-sensitive adhesive sheets prepared according to Examples 1 and 2 and Comparative Examples 1 and 2 were evaluated on adhesive strength, heat peelability, and displacement of the heat-peelable adhesive layer according to the following methods. The results are shown in Table 1.

Adhesive Strength

The prepared heat-peelable pressure-sensitive adhesive sheets were cut into tape-form pieces 20 mm wide and each applied to a green sheet to give samples. The samples were subjected to peeling at ordinary temperature, a peel speed of 300 mm/min, and a peel angle of 180 degrees, and loads thereupon were measured.

Heat Peelability

Samples were prepared by the procedure as above, were heated at 130° C. for 1 minute, and were visually observed whether or not the heat-peelable pressure-sensitive adhesive sheets peeled off from the adherend. A sample undergoing peeling was evaluated as having “good” heat peelability, and a sample undergoing peeling was evaluated as having “poor” heat peelability.

The pressure-sensitive adhesive sheets were cut to square pieces with an area of 2 cm², and the square pieces were applied to a green sheet to give samples. Each of the samples was subjected to pressurization at ordinary temperature and at a pressure of 2 MPa for 3 seconds a total of 100 times, the squeeze out (displacement) of the pressure-sensitive adhesive was measured, and the average of the largest amounts of squeeze out among the four sides was calculated. A sample showing an average squeeze out of 0.02 mm or less was evaluated as being “good” in resistance to displacement of adhesive, and a sample having an average squeeze out of more than 0.02 mm was evaluated as being “poor” in resistance to displacement of adhesive.

TABLE 1

| | Adhesive | | Resistance to displacement |
|---|---|---|---|
| | strength | Heat | of pressure-sensitive |
| | (N/20 mm) | peelability | adhesive (mm) |
| Example 1 | 0.8 | Good | Good (0.01) |
| Comparative | 1.6 | Good | Poor (0.03) |
| Example 1 | | | |
| Example 2 | 10.5 | Good | Good (0.02) |
| Comparative | 13.0 | Good | Poor (0.06) |
| Example 2 | | | |

### Example 3

In toluene were uniformly dissolved 100 parts by weight of an acrylic copolymer, 10 parts by weight of montmorillonite (supplied by Kunimine Industries, Co., Ltd. under the trade name “Kunipia G”) as a layered silicate, 1.5 parts by weight of an isocyanate crosslinking agent, and 30 parts by weight of heat-expandable microspheres (supplied by Matsumoto Yushi-Seiyaku Co., Ltd. under the trade name “Matsumoto Microsphere F80SD”) which will expand at 150° C. to give a coating composition; and the coating composition was applied to a poly(ethylene terephthalate) film 100 μm thick as a substrate, dried, and thereby yielded a heat-peelable pressure-sensitive adhesive sheet according to the present invention, having a thickness after drying of 50 μm. The acrylic copolymer used herein was composed of 70 parts by weight of ethyl acrylate, 30 parts by weight of 2-ethylhexyl acrylate, 4 parts by weight of hydroxyethyl acrylate, and 5 parts by weight of methyl methacrylate.

### Example 4

In toluene were uniformly dissolved 100 parts by weight of an acrylic copolymer, 40 parts by weight of a montmorillonite (supplied by Kunimine Industries, Co., Ltd. under the trade name “Kunipia G”) as a layered silicate, 1.5 parts by weight of an isocyanate crosslinking agent, 5 parts by weight of a rosin phenol tackifier, and 30 parts by weight of heat-expandable microspheres (supplied by Matsumoto Yushi-Seiyaku Co., Ltd. under the trade name “Matsumoto Microsphere F80SD”) which will expand at 150° C. to give a coating composition; and the coating composition was applied to a poly(ethylene terephthalate) film 100 μm thick as a substrate, dried, and thereby yielded a heat-peelable pressure-sensitive adhesive sheet according to the present invention, having a thickness after drying of 50 μm. The acrylic copolymer used herein was composed of 70 parts by weight of ethyl acrylate, 30 parts by weight of 2-ethylhexyl acrylate, 4 parts by weight of hydroxyethyl acrylate, and 5 parts by weight of methyl methacrylate.

### Comparative Example 3

In toluene were uniformly dissolved 100 parts by weight of an acrylic copolymer, 3 parts by weight of a rosin phenol tackifier, and 30 parts by weight of heat-expandable microspheres (supplied by Matsumoto Yushi-Seiyaku Co., Ltd. under the trade name “Matsumoto Microsphere F80SD”) which will expand at 150° C. to give a coating composition; and the coating composition was applied to a poly(ethylene terephthalate) film 100 μm thick as a substrate, dried, and thereby yielded a heat-peelable pressure-sensitive adhesive sheet having a thickness after drying of 50 μm. The acrylic copolymer used herein was composed of 70 parts by weight of ethyl acrylate, 30 parts by weight of 2-ethylhexyl acrylate, 5 parts by weight of hydroxyethyl acrylate, and 5 parts by weight of methyl methacrylate.

### (Evaluations)

The heat-peelable pressure-sensitive adhesive sheets prepared according to Examples 3 and 4 and Comparative Example 3 were evaluated on the following properties. The results are shown in Table 2.

Adhesive Strength at 100° C.

The pressure-sensitive adhesive sheets prepared according to the examples and comparative example were cut to tape-form pieces 20 mm wide and 140 mm long, the pieces were applied to a poly(ethylene terephthalate) film 25 μm thick and 30 mm wide in accordance with Japanese Industrial Standards (JIS) Z 0237 under a normal condition, the resulting articles were mounted to a tensile tester with a high-temperature chamber previously set at 100° C., left stand for 5 minutes, subjected to peeling at a peel speed of 300 mm/min and a peel angle of 180 degrees, and loads upon peeling were measured.

Chip-Holding Power During Force-Cutting

A green sheet (ceramic green sheet) was applied to each of the pressure-sensitive adhesive sheets prepared according to the examples and comparative example, the resulting articles were left stand in an atmosphere of 100° C. for 5 minutes, and subjected to force-cutting into chips of “0603” (0.6 mm by 0.3 mm) size. In this procedure, a sample having a ratio of chips separated from the pressure-sensitive adhesive sheet of 0.1% or less based on the total chips was evaluated as having “good” chip-holding power; and a sample having a ratio of chips separated from the pressure-sensitive adhesive sheet of more than 0.1% based on the total chips was evaluated as having “poor” chip-holding power.

Heat Peelability

After the chip-holding power during force-cutting was evaluated, the sample pressure-sensitive adhesive sheets bearing chip-like green sheets were subjected to a heating treatment on a hot plate at 150° C. for 60 seconds. A sample from which all the chip-like green sheets were peeled was evaluated as having “good” heat peelability; and a sample on which one or more chip-like green sheets remained was evaluated as having “poor” heat peelability.

TABLE 2

| | Adhesive strength at | Chip-holding power | Heat |
|---|---|---|---|
| | 100° C. (N/20 mm) | during force-cutting | peelability |
| Example 3 | 1.27 | Good | Good |
| Example 4 | 2.54 | Good | Good |
| Comparative | 0.60 | Poor | Good |
| Example 3 | | | |

The results in Table 2 demonstrate that the heat-peelable pressure-sensitive adhesive sheets according to the present invention excel in adhesive strength in an atmosphere of 100° C., as compared to the heat-peelable pressure-sensitive adhesive sheet according to Comparative Example 3, are thereby resistant to chip separation during force cutting, and can be easily removed from the adherends through heating.

### Example 5

Rubber-Like Organic Elastic Layer

In toluene were uniformly dissolved 100 parts by weight of an acrylic copolymer and 2 parts by weight of an isocyanate crosslinking agent (supplied by Nippon Polyurethane Industry Co., Ltd. under the trade name “CORONATE L”) to give a coating composition, and the coating composition was applied to a polyester film 100 μm thick, and dried by heating at 120° C. for 2 minutes, to give a rubber-like organic elastic layer having a thickness after drying of 10 μm. The acrylic copolymer used herein was composed of 70 parts by weight of ethyl acrylate, 30 parts by weight of 2-ethylhexyl acrylate, 5 parts by weight of hydroxyethyl acrylate, and 5 parts by weight of methyl methacrylate.

Heat-Peelable Pressure-Sensitive Adhesive Layer

In toluene were uniformly dissolved 100 parts by weight of an acrylic copolymer, 2.5 parts by weight of an isocyanate crosslinking agent (supplied by Nippon Polyurethane Industry Co., Ltd. under the trade name “CORONATE L”), 30 parts by weight of heat-expandable microspheres (supplied by Matsumoto Yushi-Seiyaku Co., Ltd. under the trade name “Microsphere F80SD”) which will expand at 150° C., 10 parts by weight of a rosin phenol tackifier, and, as a layered silicate, 10 parts by weight of a montmorillonite (supplied by Kunimine Industries, Co., Ltd. under the trade name “Kunipia G”, having an average length of 0.1 μm) to give a coating composition. The coating composition was applied to a PET (poly(ethylene terephthalate)) film whose surface had been treated to be releasable, and the applied film was dried at 70° C. for 3 minutes to give a heat-peelable pressure-sensitive adhesive layer having a thickness after drying of 30 μm. The acrylic copolymer was composed of 70 parts by weight of ethyl acrylate, 30 parts by weight of 2-ethylhexyl acrylate, 5 parts by weight of hydroxyethyl acrylate, and 5 parts by weights of methyl methacrylate.

Heat-Peelable Pressure-Sensitive Adhesive Sheet

The rubber-like organic elastic layer was affixed to the heat-peelable pressure-sensitive adhesive layer and thereby yielded a heat-peelable pressure-sensitive adhesive sheet according to the present invention.

### Example 6

A heat-peelable pressure-sensitive adhesive sheet according to the present invention was prepared by the procedure of Example 5, except for using the layered silicate in an amount of 30 parts by weight.

### Comparative Example 4

A heat-peelable pressure-sensitive adhesive sheet was prepared by the procedure of Example 5, except for not using the layered silicate.

### Referential Example

### First Heat-Peelable Pressure-Sensitive Adhesive Sheet

A heat-peelable pressure-sensitive adhesive sheet was prepared by the procedure of Comparative Example 4, except for using heat-expandable microspheres (supplied by Matsumoto Yushi-Seiyaku Co., Ltd. under the trade name “Microsphere F50D”) that will expand at 120° C. instead of the heat-expandable microspheres that will expand at 150° C.

### (Tests)

Transfer Rate

Transfer percentages of the heat-peelable pressure-sensitive adhesive sheets prepared according to Examples 5 and 6 and Comparative Example 4 were evaluated according to the following procedure. The term “transfer percentage” refers to a percentage of adherends successfully transferred from a first heat-peelable pressure-sensitive adhesive sheet to a sample heat-peelable pressure-sensitive adhesive sheet. Chips of “0603” (0.6 mm by 0.3 mm) size as adherends were applied to the first heat-peelable pressure-sensitive adhesive sheet prepared according to the referential example. Each of the heat-peelable pressure-sensitive adhesive sheets prepared according to Examples 5 and 6 and Comparative Example 4 was affixed to a side of each adherend opposite to the first pressure-sensitive adhesive sheet, and the first pressure-sensitive adhesive sheet was heated on a hot plate at 130° C. for 30 seconds to thereby transfer the adherends from the first pressure-sensitive adhesive sheet to the second pressure-sensitive adhesive sheet. Chips which had been successfully transferred to the second pressure-sensitive adhesive sheet upon heating without separating from the second pressure-sensitive adhesive sheet were counted, and the transfer percentages were calculated according to the equation: Transfer percentage=[(Number of chips transferred to the second pressure-sensitive adhesive sheet)/(Number of chips initially affixed to the first pressure-sensitive adhesive sheet)]×100. The calculated transfer percentages are shown in Table 3.

Adhesive Strength in Atmosphere of 110° C.

The pressure-sensitive adhesive sheets prepared according to Examples 5 and 6 and Comparative Example 4 were cut into tape-like pieces 20 mm wide, and each of the pieces was affixed to a green sheet to give samples. The samples were subjected to peeling in an atmosphere of 110° C. at a peel speed of 300 mm/min and a peel angle of 180 degrees, and the loads upon peeling were measured. The results are shown in Table 3.

TABLE 3

| | Adhesive strength in | Transfer |
|---|---|---|
| | atmosphere of 110° C. | percentage |
| | (N/20 mm) | (%) |
| Example 5 | 1.05 | 92 |
| Example 6 | 1.73 | 98 |
| Comparative Example 4 | 0.46 | 79 |

The heat-peelable pressure-sensitive adhesive sheets according to the present invention containing a layered silicate in the heat-peelable pressure-sensitive adhesive layer maintain an adequate adhesive strength even in a high-temperature atmosphere to give satisfactory percentages of chips transferred from the first heat-peelable pressure-sensitive adhesive sheet to the second heat-peelable pressure-sensitive adhesive sheet. In contrast, the pressure-sensitive adhesive sheet according to Comparative Example 4 shows a low percentage of chips transferred from the first pressure-sensitive adhesive sheet to the second pressure-sensitive adhesive sheet. This is because the pressure-sensitive adhesive sheet contains no layered silicate and shows a low adhesive strength in a high-temperature atmosphere, whereby heat applied for the heating-peeling treatment of the first pressure-sensitive adhesive sheet travels also to the second pressure-sensitive adhesive sheet and lowers the adhesive strength of the second pressure-sensitive adhesive sheet, and this causes the separation of chips from the second pressure-sensitive adhesive sheet.

### INDUSTRIAL APPLICABILITY

The heat-peelable pressure-sensitive adhesive sheets according to the present invention are resistant to deformation of the heat-peelable pressure-sensitive adhesive layer even upon repeated high-pressure pressing operations and show high cohesive strength and satisfactory adhesive properties even in a high-temperature atmosphere. The heat-peelable pressure-sensitive adhesive sheets are therefore advantageously used as pressure-sensitive adhesive sheets for working or processing of electronic components such as multilayer ceramic electronic components. Typically, when used in the step of pressing green sheets, they are resistant to the displacement and deformation of the pressure-sensitive adhesive. When used in the step of cutting a multilayer green sheet in a high-temperature atmosphere typically through force-cutting, they help to prevent chip separation during operation and enable cutting with high accuracy.

Use of the heat-peelable pressure-sensitive adhesive sheets as pressure-sensitive adhesive sheets for use in working in respective steps in production of electronic components improves the accuracy and efficiency of the operation and gives chip-like electronic components with very high quality.

The heat-peelable pressure-sensitive adhesive sheets, once an aimed bonding operation is accomplished, can be easily removed from electronic components by a heating-peeling treatment without applying stress on the electronic components.

1. A heat-peelable pressure-sensitive adhesive sheet comprising a substrate and, arranged on or above at least one side thereof, a heat-peelable pressure-sensitive adhesive layer containing heat-expandable microspheres and a layered silicate.

2. The heat-peelable pressure-sensitive adhesive sheet of claim 1, wherein the layered silicate is present in a content of from 1 to 200 parts by weight per 100 parts by weight of a base polymer constituting the heat-peelable pressure-sensitive adhesive layer.

3. A process for producing an electronic component, the process comprising the steps of stacking two or more green sheets bearing one or more printed electrodes thereon to give a laminate; and pressing the laminate to give a multilayer green sheet, wherein these steps are performed on the heat-peelable pressure-sensitive adhesive sheet of claim 1.

4. A process for producing an electronic component, the process comprising the steps of affixing a multilayer ceramic sheet to the heat-peelable pressure-sensitive adhesive sheet of claim 1; and cutting the multilayer ceramic sheet on the pressure-sensitive adhesive sheet to give a chip-like electronic component.

5. A process for producing a chip-like electronic component having an external electrode, the process comprising the steps of arraying the chip-like electronic component on an adhesive face of a first heat-peelable pressure-sensitive adhesive sheet; providing an external electrode on a side of the chip-like electronic component opposite to the first heat-peelable pressure-sensitive adhesive sheet; affixing the heat-peelable pressure-sensitive adhesive sheet of claim 1 to the resulting external electrodes on the chip-like electronic component; removing the first heat-peelable pressure-sensitive adhesive sheet from the chip-like electronic component through heating to expose a side of the chip-like electronic component; and providing another external electrode on the exposed side of the chip-like electronic component from which the first heat-peelable pressure-sensitive adhesive sheet has been removed.

6. A process for producing an electronic component, the process comprising the steps of stacking two or more green sheets bearing one or more printed electrodes thereon to give a laminate; and pressing the laminate to give a multilayer green sheet, wherein these steps are performed on the heat-peelable pressure-sensitive adhesive sheet of claim 2.

7. A process for producing an electronic component, the process comprising the steps of affixing a multilayer ceramic sheet to the heat-peelable pressure-sensitive adhesive sheet of claim 2; and cutting the multilayer ceramic sheet on the pressure-sensitive adhesive sheet to give a chip-like electronic component.

8. A process for producing a chip-like electronic component having an external electrode, the process comprising the steps of arraying the chip-like electronic component on an adhesive face of a first heat-peelable pressure-sensitive adhesive sheet; providing an external electrode on a side of the chip-like electronic component opposite to the first heat-peelable pressure-sensitive adhesive sheet; affixing the heat-peelable pressure-sensitive adhesive sheet of claim 2 to the resulting external electrodes on the chip-like electronic component; removing the first heat-peelable pressure-sensitive adhesive sheet from the chip-like electronic component through heating to expose a side of the chip-like electronic component; and providing another external electrode on the exposed side of the chip-like electronic component from which the first heat-peelable pressure-sensitive adhesive sheet has been removed.
